(19) United States
(12) Patent Application Publication
(10) Pub. No.: US 2011/0280744 A1
(43) Pub. Date: Nov. 17, 2011

(54) Universal Mount For A Variable Speed Pump Drive User Interface

(76) Inventors: Gary ORTIZ, Clemmons, NC (US); Jason W. Parcell, Winston-Salem, NC (US); Dwayne Emory Clark, Summerfield, NC (US)

(21) Appl. No.: 13/034,389

(22) Filed: Feb. 24, 2011

Related U.S. Application Data
(60) Provisional application No. 61/308,241, filed on Feb. 25, 2010.

(51) Int. Cl. F04B 53/00; B23P 11/00

(52) U.S. Cl. 417/313; 29/428

(57) ABSTRACT

Disclosed herein is a user interface that can be universally mounted to a combination variable speed pump and a drive assembly therefor. The user interface is universally configured to be selectively mounted to the drive assembly and/or to an environmental surface that is remotely located from the drive assembly. The user interface is universally configured to be selectively mounted to the drive assembly in any one of a plurality of available positions relative thereto.

### CROSS-REFERENCE TO RELATED APPLICATION

This application claims the benefit of U.S. Provisional Patent Application No. 61/308,241 filed Feb. 25, 2010, the disclosure of which is incorporated herein by reference in its entirety.

### TECHNICAL FIELD

The present disclosure relates to an universal mount, and more particularly, to an universal mount for a variable speed pump drive user interface.

### BACKGROUND

Various controllers have, in the past, been developed for pools. One example is a controller that controls a variable speed pump and automatically adjusts the speed of the pump based on operating conditions. The controller typically includes a user interface (e.g., keypad) for allowing a user to interact with a stored control program for controlling the variable speed pump. Some of these user interfaces are mounted to the pump in only one orientation. Other user interfaces are mounted remotely from the pump.

Pumps must adapt to the specific configuration of an existing fluid circulation system. For example, a return line of the fluid circulation system (which is typically connected to a pump, directly or indirectly) could be positioned in a particular direction, and therefore, the outlet of the pump must be aligned with the return line accordingly. As a result, the pump could be oriented in such a manner that a user could have difficultly accessing the interface.

Accordingly, it would be desirable for an user to easily access the user interface regardless of the orientation of the pump.

### SUMMARY

Disclosed herein are systems and methods for universally mounting a user interface for a combination variable speed pump and a drive assembly therefor. In some aspects, the user interface is universally configured to be selectively mounted to (i) the drive assembly, and/or (ii) an environmental surface such as the outside wall of a house. In some aspects, the user interface is universally configured to be selectively mounted to the drive assembly in any one of a plurality of available positions relative thereto, and, in this regard, the user interface can be selectively oriented at the pump by a user to enhance physical access of the user to the interface at the location at which the combination is positioned.

The present disclosure relates to a variable speed pumping system. More particularly, the variable speed pumping system includes a pumping assembly that includes at least a pump, a motor, and a drive assembly. The pumping assembly has a mount, and a user interface selectively positionable among a plurality of positions with respect to the mount.

In an exemplary embodiment, the variable speed pumping assembly includes a pump, a variable speed motor in communication with the pump, and a drive assembly sized to control the variable speed motor. A user interface is selectively positionable among a plurality of positions with respect to the pump, variable speed motor, and/or the drive assembly.

A method is disclosed for selectively positioning a user interface relative to a pumping assembly that includes at least a pump, a motor, and a drive assembly. The method includes the steps of mounting the user interface to the pumping assembly in a first position, and moving the user interface to a second position with respect to the pumping assembly. The second position is different from the first position.

### BRIEF DESCRIPTION OF THE DRAWINGS

For a more complete understanding of the present disclosure, reference is made to the following Detailed Description of the Exemplary Embodiment(s), considered in conjunction with the accompanying drawings, in which:

FIG. 1 is a partially exploded perspective view of a variable speed pumping system, the variable speed pumping system including a variable speed pumping assembly that includes a variable speed pump, a motor for the variable speed pump, a drive assembly for the motor, and a user interface module for the drive assembly;

FIG. 2 is a perspective view of the drive assembly shown in FIG. 1;

FIG. 3 is an exploded view of the drive assembly shown in FIG. 1;

FIG. 4 shows four perspective views of the variable speed pumping system shown in FIG. 1, showing the interface module in four different positions relative to the drive assembly;

FIG. 5 is a front view of the interface module shown in FIG. 1 mounted at a location remote from the drive assembly;

FIG. 6 is an exploded view of the interface module and a mounting bracket;

FIG. 7 is a perspective view of the variable speed pumping system shown in FIG. 1, showing a blank cover over the drive assembly;

FIG. 8 is a perspective view of the drive assembly shown in FIG. 1;

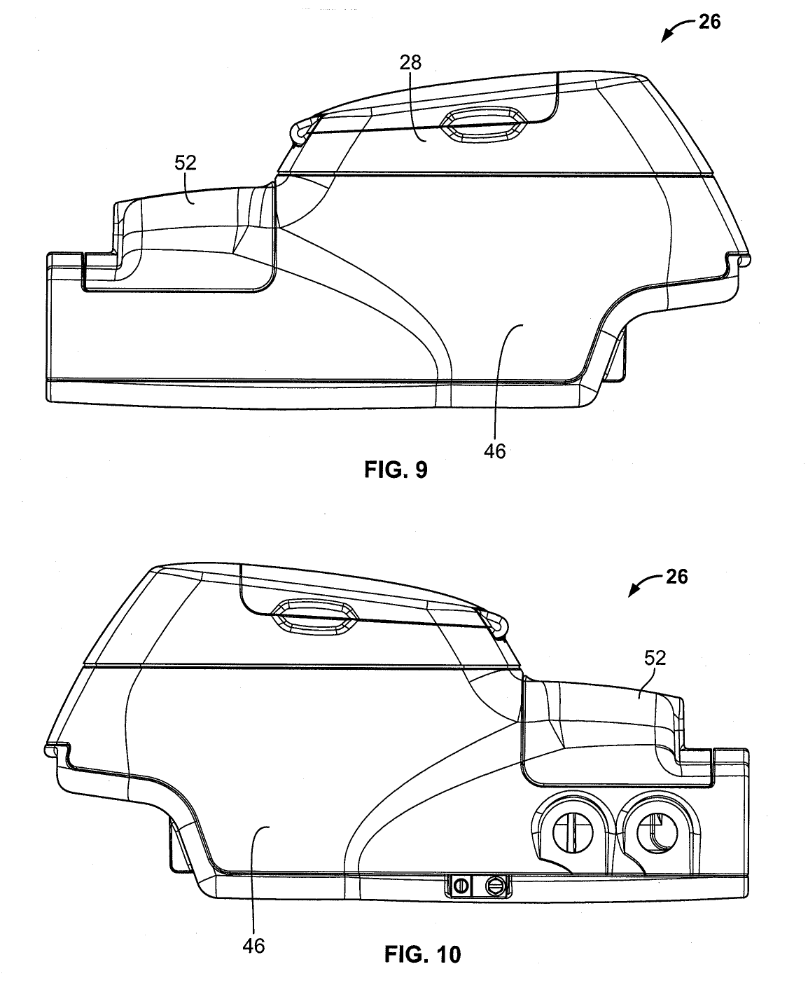

FIGS. 9 and 10 are side views of the drive assembly shown in FIG. 1;

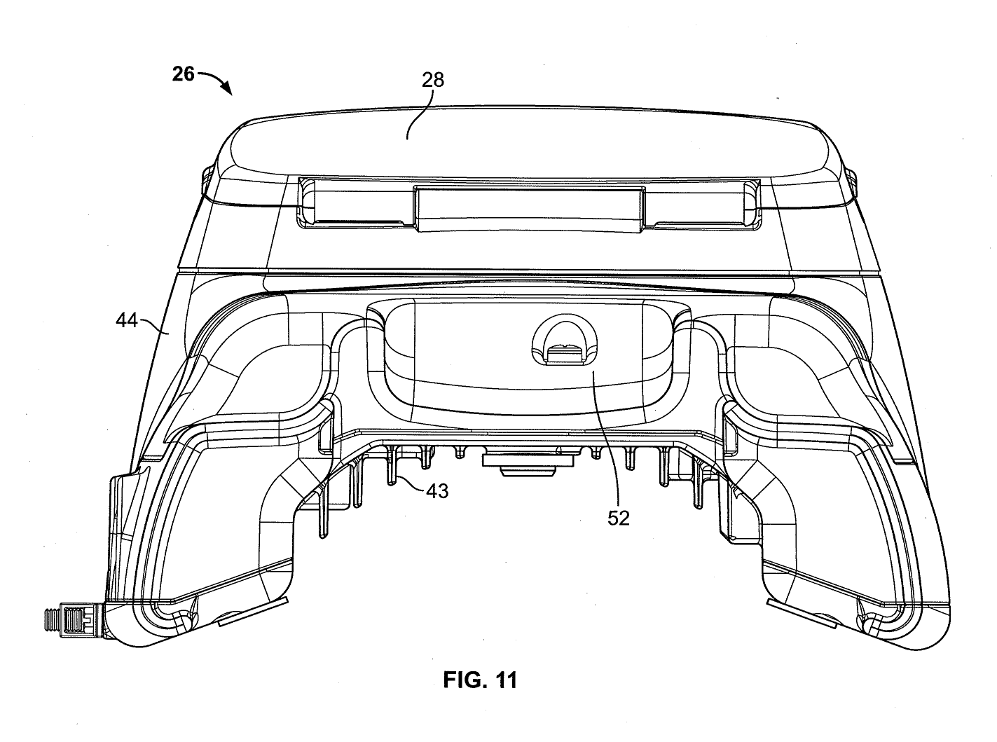

FIGS. 11-14 are views of the drive assembly shown in FIG. 1;

FIG. 15 is a cross-sectional line view, taken along section lines 15-15 and looking in the direction of the arrows, of the drive assembly shown in FIG. 8;

FIG. 16 is a cross-sectional line view, taken along section lines 16-16 and looking in the direction of the arrows, of the drive assembly shown in FIG. 8;

FIG. 17 is a perspective view of a wiring compartment cover for the drive assembly shown in FIG. 1;

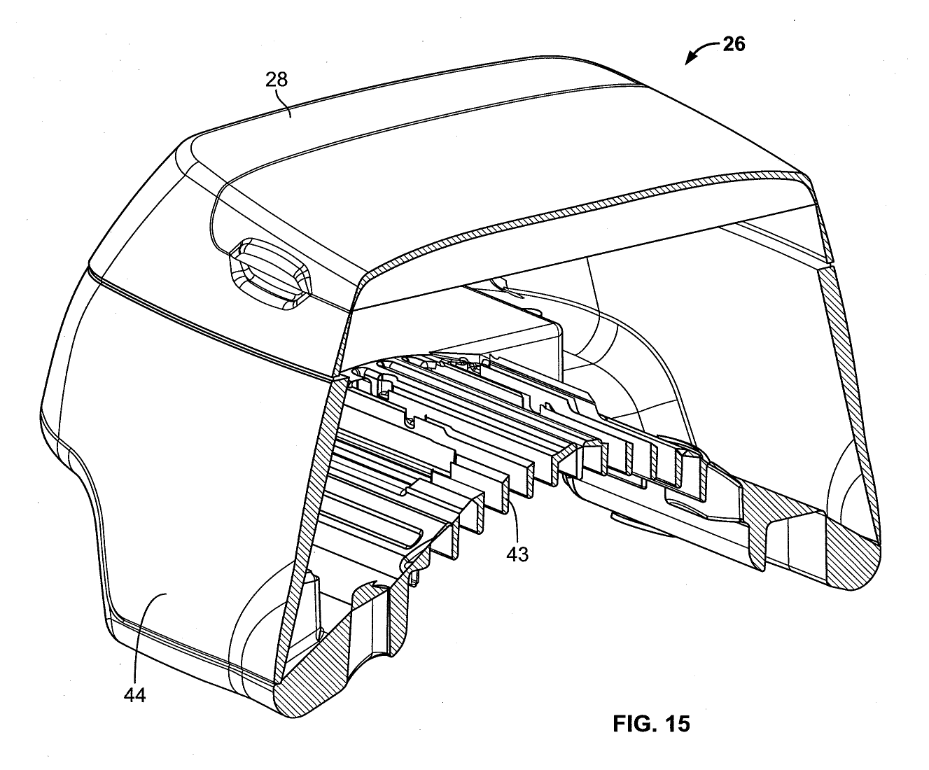

FIG. 18 is a perspective view of the interface module shown in FIG. 1;

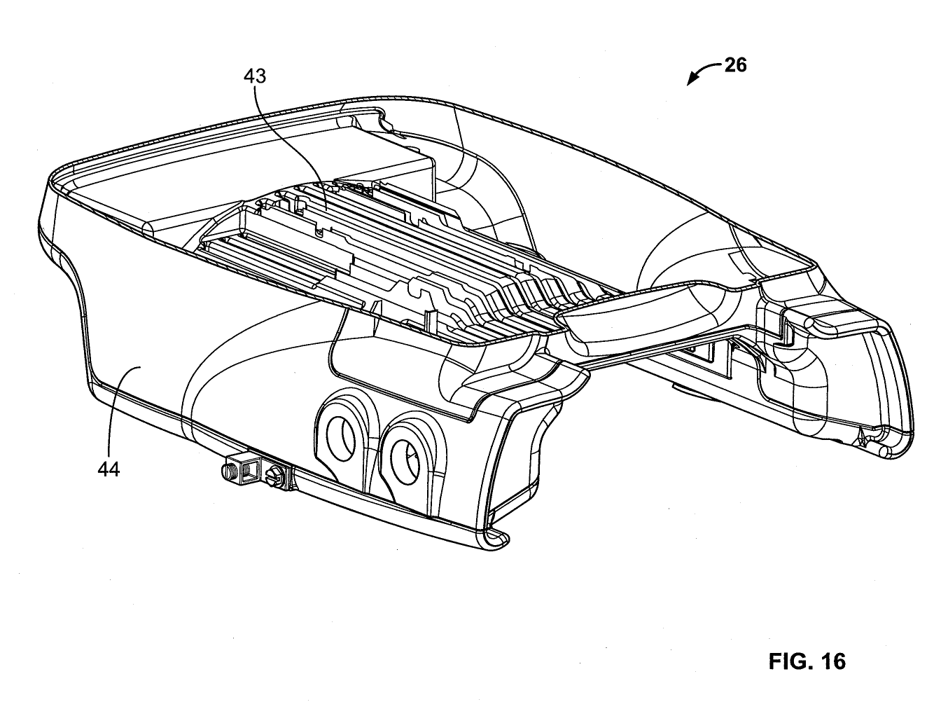

FIG. 19 is a top view of an user interface control panel shown in FIG. 1; and

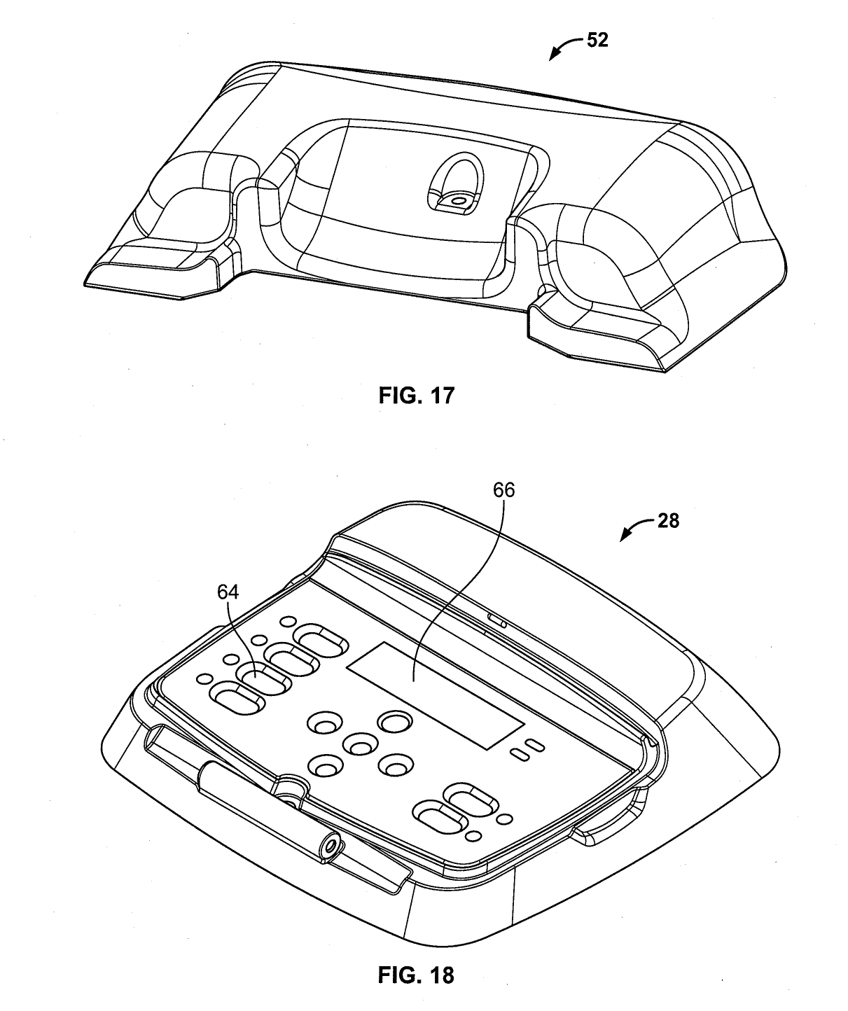

FIG. 20 is a perspective view of the blank cover shown in FIG. 7.

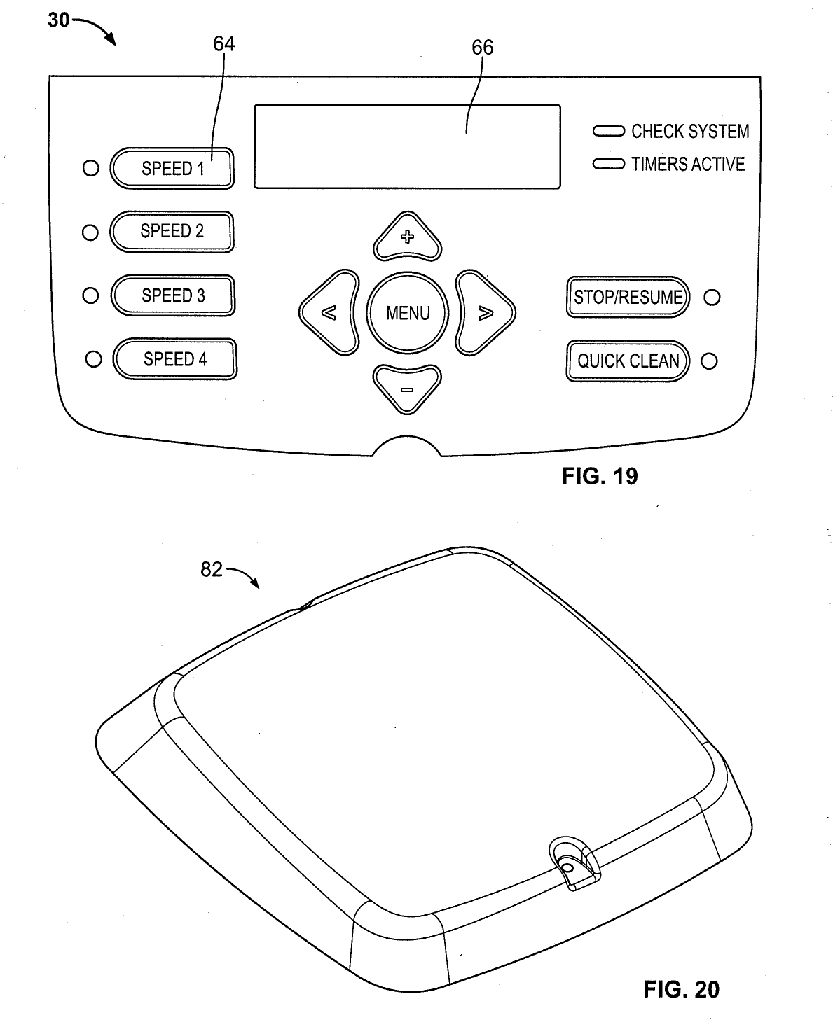

### DETAILED DESCRIPTION OF EXEMPLARY EMBODIMENT(S)

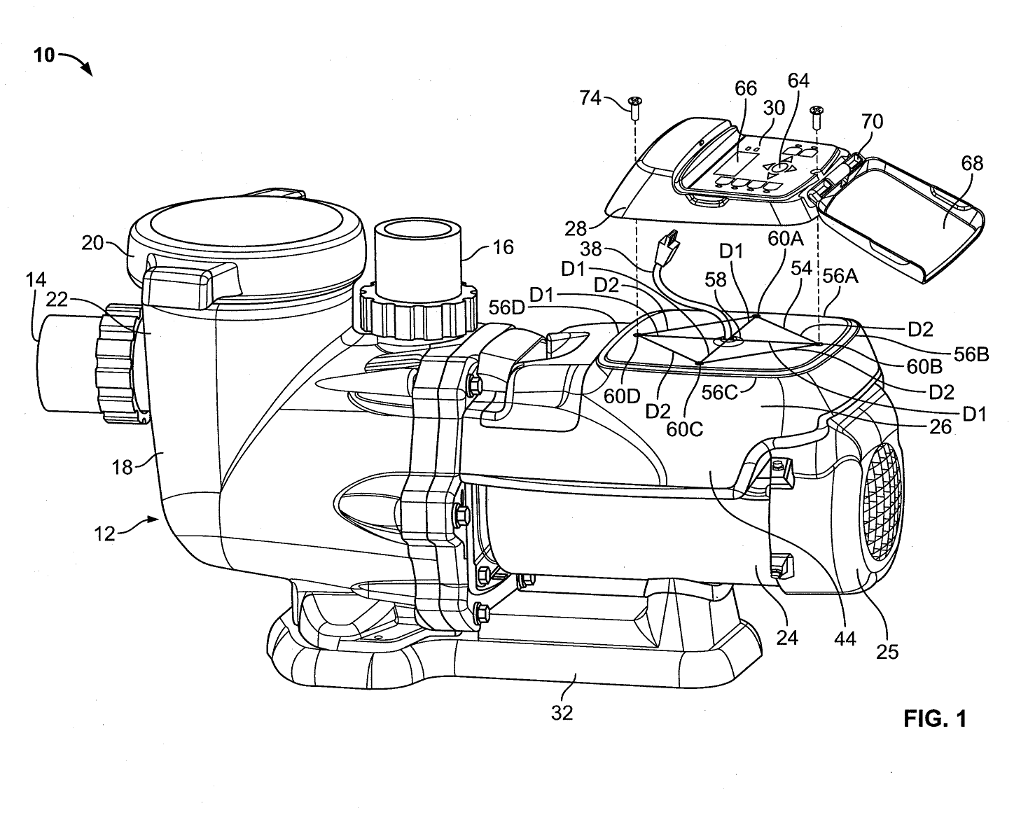

Referring to FIG. 1, a variable speed pumping system 10 is provided for connection to a fluid circulation line of a swimming pool and/or other recreational body of water, such as a spa, etc. The variable speed pumping system 10 is typically connected to the fluid circulation line so as to pump dirty water therethrough and return clean water thereto. Other devices might be connected along the fluid circulation line, such as sand filters, chlorinators, and other devices known in the art.

The variable speed pumping system 10 could be provided with structures and functions known in the art. As a non-limiting example, reference is made to the TriStar Energy Solution® Variable Speed Pump and Control of Hayward Industries, Inc., Elizabeth, N.J.

The variable speed pumping system 10 includes a variable speed pumping assembly that has a variable speed pump 12 which has an inlet 14 for receiving fluid from the fluid circulation line and an outlet 16 for discharging fluid to the fluid connection line. The variable speed pump 12 includes a strainer chamber 18 positioned between the inlet 14 and the outlet 16. The strainer chamber 18 includes a strainer basket (not shown) for filtering water that flows into the inlet 14. A circular cover 20 is secured to a top end 22 of the strainer chamber 18.

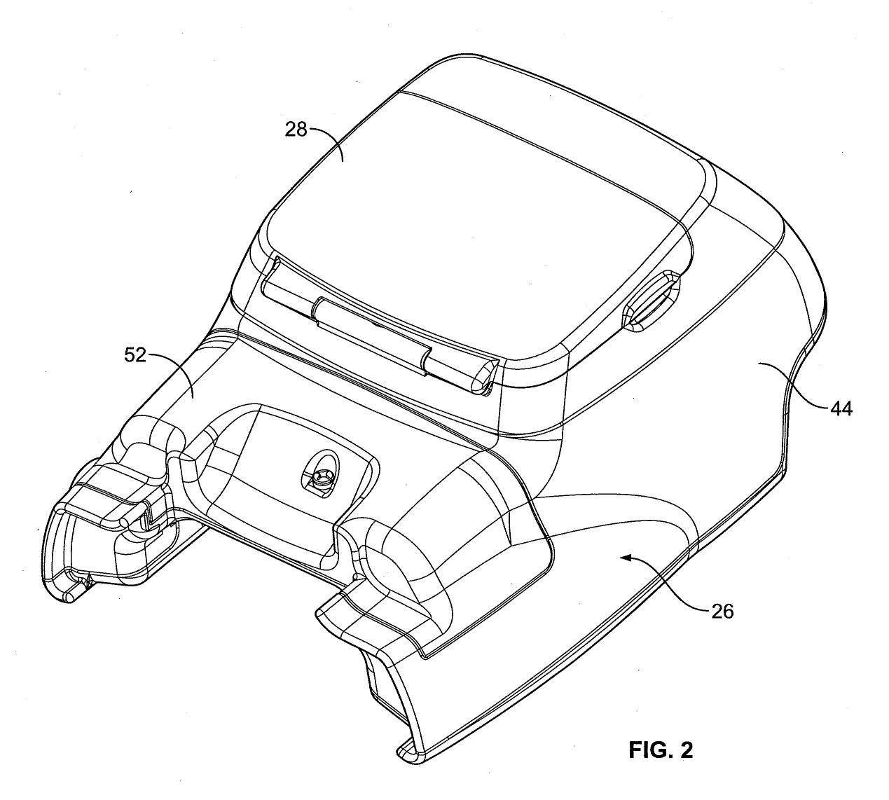

The variable speed pumping assembly further includes a variable speed motor 24 to drive the variable speed pump 12, and a drive assembly 26 (FIG. 2) to variably control the speed of the motor 24. A fan shroud 25 is provided to cover one end of the motor 24. An interface module 28 with a user interface control panel 30 is provided in electrical communication with the drive assembly 26 for user input of parameters, as will be explained in further detail hereinafter.

The motor 24 is connected to the strainer chamber 18, and drives an impeller to pump fluids from the inlet 14, through the strainer chamber 18, and out the outlet 16. The drive assembly 26 is situated on top of the motor 24. A base 32 is positioned under the strainer chamber 18 and the motor 24 to provide stability and mounting.

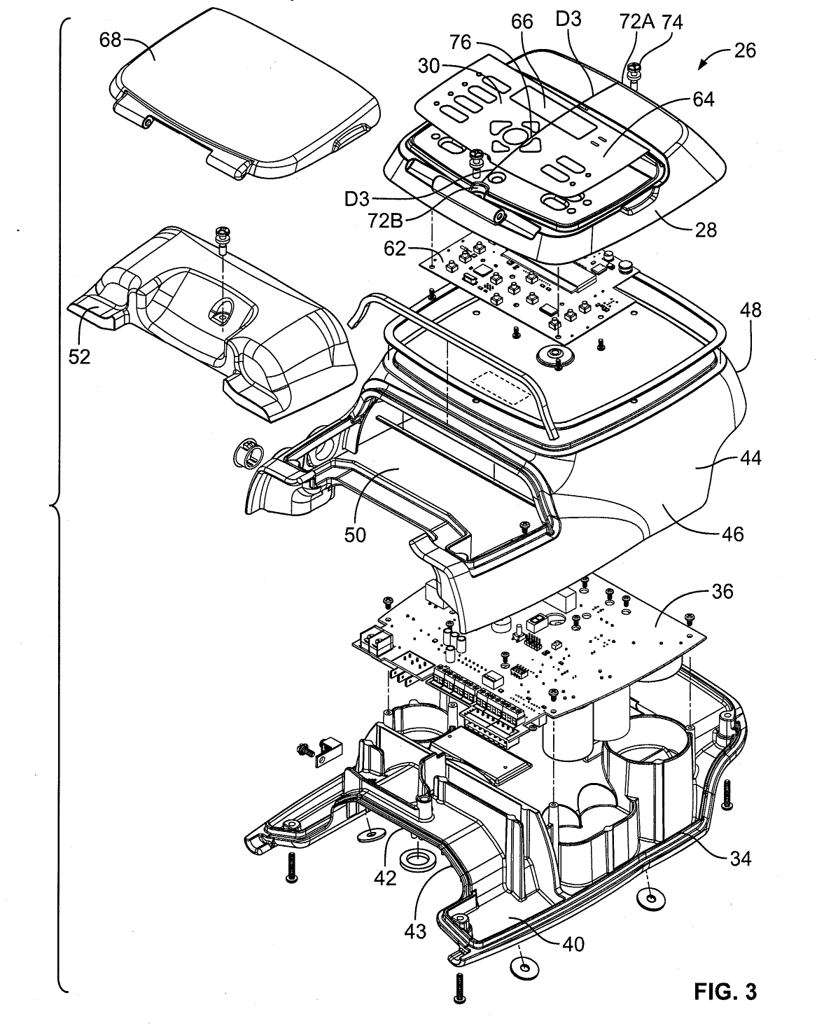

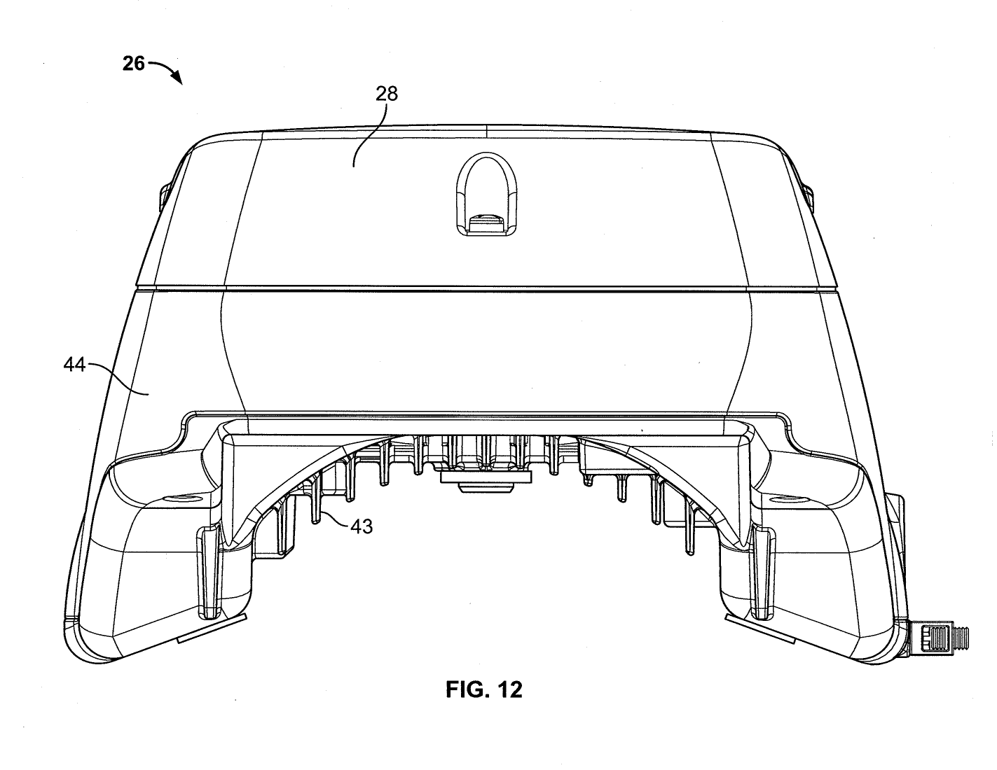

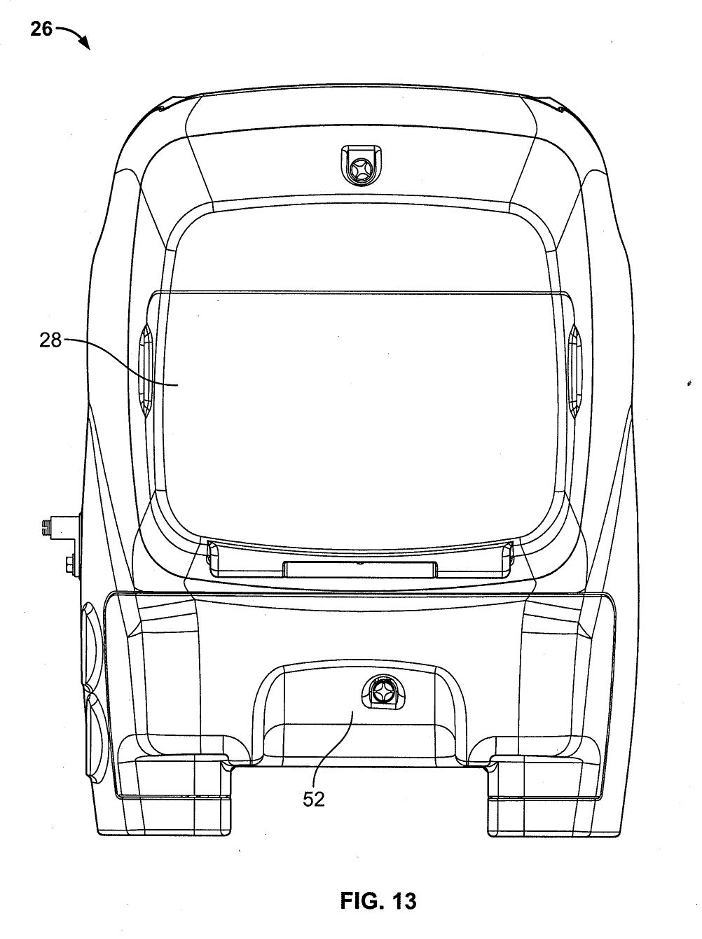

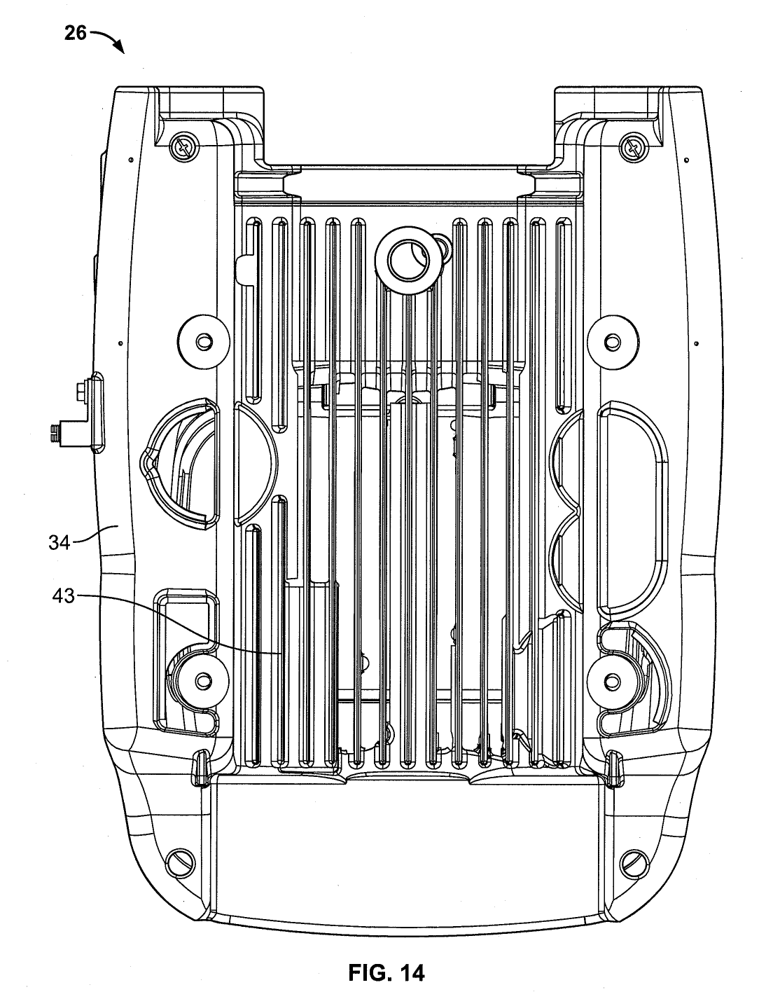

With reference to FIG. 3, the drive assembly 26 includes an enclosure 34 that contains the electrical components, such as a main printed circuit board 36 and a controller with a processor, for driving the motor 24. An electrical cable 38 (FIG. 1) is connected to the electrical components. The enclosure 34 includes a peripheral portion 40 and an interior portion 42 that is elevated relative to the peripheral portion 40. The bottom of the drive assembly 26 includes a heat sink 43 (see FIGS. 11, 12, and 14-16) configured to allow heat to be properly dissipated away from the electrical components. The heat sink 43 could be made from any suitable material, such as a thermally conductive and electrically insulative material.

The drive assembly 26 further includes a housing 44 positioned over the enclosure 34. The housing 44 has side walls 46 and a rear wall 48. The housing 44 has an opening 50 for allowing access to the electrical components situated in the enclosure 34. A wiring compartment cover 52 is provided to close off the opening 50 formed in the housing 44.

Referring to FIG. 1, the housing 44 has a top 54 that is substantially planar, and has four peripheral edges 56A-D, which cooperate to form a substantially square shape. Opposing peripheral edges are generally planar and parallel to each other. While the top 54 of the housing 44 is shown as having a substantially square shape, the top 54 of the housing 44 could have other shapes, e.g., circular, etc.

A center opening 58 is formed through the top 54 of the housing 44 of the drive assembly 26 to allow the electrical cable 38 to extend therethrough, and a plurality of apertures 60A-D is formed in the top 54 of the housing 44 for reasons to be described hereinafter. The apertures 60A-D are positioned at substantially the same distance from the center opening 58. In particular, a first aperture 60A is spaced a predetermined distance D1 from the opening 58 along the horizontal axis. A second aperture 60B is spaced substantially the same predetermined distance D1 from the opening 58. Likewise, a third aperture 60C is spaced substantially the same predetermined distance D1 from the opening 58. A fourth aperture 60D is spaced substantially the same predetermined distance D1 from the opening 58. In this manner, the distance between each aperture 60A, 60B, 60C, or 60D and the center opening 58 is substantially the same.

Additionally, adjacent apertures 60A-B, 60B-C, 60C-D, or 60D-A are positioned substantially equidistance from each other. In particular, the first aperture 60A is spaced substantially a predetermined distance D2 from the second aperture 60B. The second aperture 60B is spaced substantially the same predetermined distance D2 from the third aperture 60C. Likewise, the third aperture 60C is spaced substantially the same predetermined distance D2 from the fourth aperture 60D. The fourth aperture 60D is spaced substantially a predetermined distance D2 from the first aperture 60A. While the apertures 60A-D could be formed in various locations on the drive assembly 44, the apertures 60A-D shown in FIG. 1 are formed along the circumference of a circle.

It will be understood that while four apertures 60A-D are shown, the number of apertures could vary. Likewise, the distance between each adjacent aperture 60A-B, 60B-C, 60C-D, or 60D-A need not be identical, and the distance between each aperture 60A, 60B, 60C, or 60D and the center opening 58 need not be identical.

The interface module 28 is detachably secured relative to the drive assembly 26. In particular, the interface module 28 could be fastened to an exterior surface of the drive assembly 26, such as the top 54 of the housing 44 of the drive assembly 26. In this manner, the top 54 of the housing 44 of the drive assembly 26 serves as an universal mount for the interface module 28. It will be understood that the universal mount for the interface module 28 could be any exterior surface of the pump 12, the motor 24, or any other surface of the variable speed pumping system 10.

The interface module 28 contains the user interface control panel 30 and electrical components, such as an interface display printed circuit board 62 (FIG. 3). The user interface control panel 30 has a keypad 64 and a display 66 that provides information from the electrical components. The keypad 64 can include push buttons or a flat panel membrane for allowing a user to provide input, such as selecting menu options (for speed, time, etc.), answers, and/or values, etc. These quantities can be shown on the display 66, such as an LCD display. The electrical cable 38 connects the interface module 28 to the electrical components stored in the enclosure 34. The interface module 28 can receive descriptive or indicative information from the electrical components.

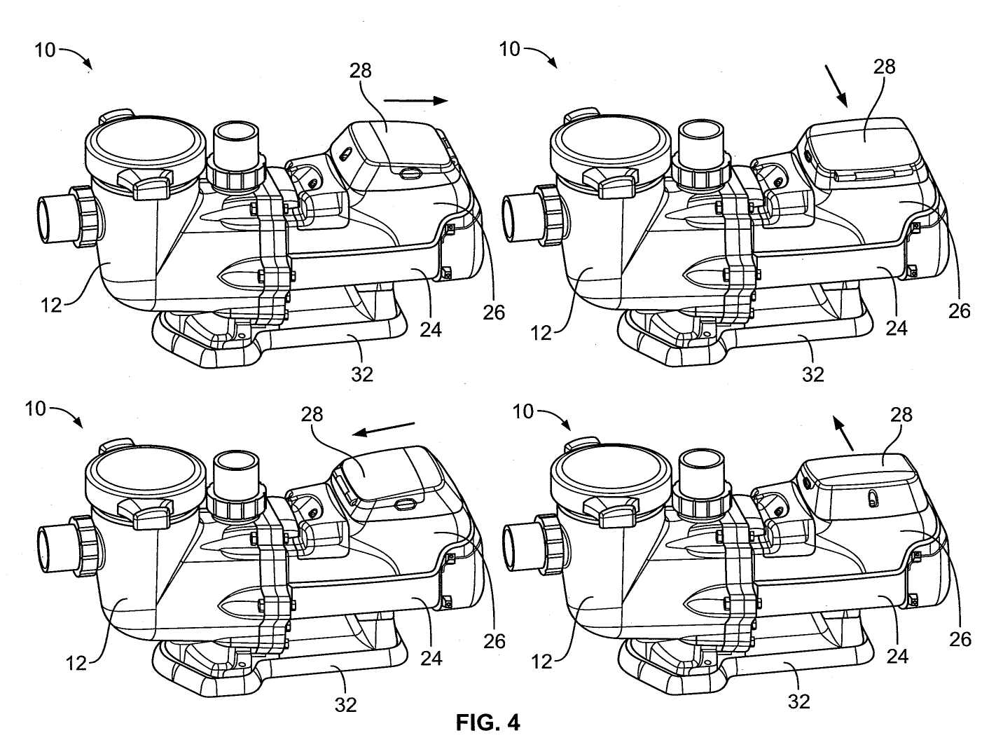

An interface cover 68 is provided to selectively cover the interface module 28. Living hinges 70 are provided for pivotally connecting the interface cover 68 to the interface module 28 such that the interface cover 68 is pivotable between a closed or retracted position, in which the interface cover 68 is positioned over the user interface control panel 30 (as shown in FIG. 4), and an unfolded or extended position, in which the interface cover 68 projects away from the user interface control panel 30 to allow access to the user interface control panel 30 (as shown in FIG. 1).

Referring to FIG. 3, the interface module 28 is shown having a substantially square shape, however, the interface module 28 could have other shapes, e.g., circular, etc. The interface module 28 includes a plurality of apertures 72A-B that are aligned with the apertures 60A-D (FIG. 1) of the housing 44, thereby enabling the interface module 28 to be removeably secured to the housing 44 by fastening means, such as screws 74.

The apertures 72A-B formed in the interface module 28 are positioned at substantially the same distance from a center 76 of the interface module 28. In particular, a first aperture 72A is spaced substantially a predetermined distance D3 from the center 76 along the horizontal axis. A second aperture 72B is spaced substantially the same predetermined distance D3 from the center 76. In this manner, the distance between each aperture 72A or 72B and the center 76 is substantially the same.

It will be understood that while two apertures 72A-B are shown, the number of apertures could vary. Likewise, the distance between each aperture 72A or 72B and the center 76 need not be identical.

In an exemplary embodiment, the interface module 28 is assembled to the drive assembly 26 with the panel retaining screws 74. The use of other mechanical locking systems to fasten the interface module 28 to the drive assembly 26 is contemplated. If the user decides to change the orientation of the interface module 28 relative to the drive assembly 26, the screws 74 are removed, the interface module 28 is rotated to a desired orientation, such as any of the orientations shown in FIG. 4, and the interface module 28 is secured to the drive assembly 26 in the desired orientation with the screws 74. The electrical cable 38 is of sufficient length to allow communication between the interface module 28 and the drive assembly 26 regardless of the orientation of the interface module 28 relative to the drive assembly 26.

In one embodiment, the orientation of the interface module 28 could be changed relative to the drive assembly 26 without removing the interface module 28 from the drive assembly 26. For example, the interface module 28 could be configured on a rotatable turret.

In view of the configuration of the apertures and the shapes of the interface module 28 and the top 54 of the housing 44 of the drive assembly 26, the interface module 28 could be selectively positionable relative to the drive assembly 26. In one embodiment, the interface module 28 could be selectively positionable relative to the drive assembly 26 about a vertical axis. As a result, the interface module 28 could be simply installed in any direction on the drive assembly 26.

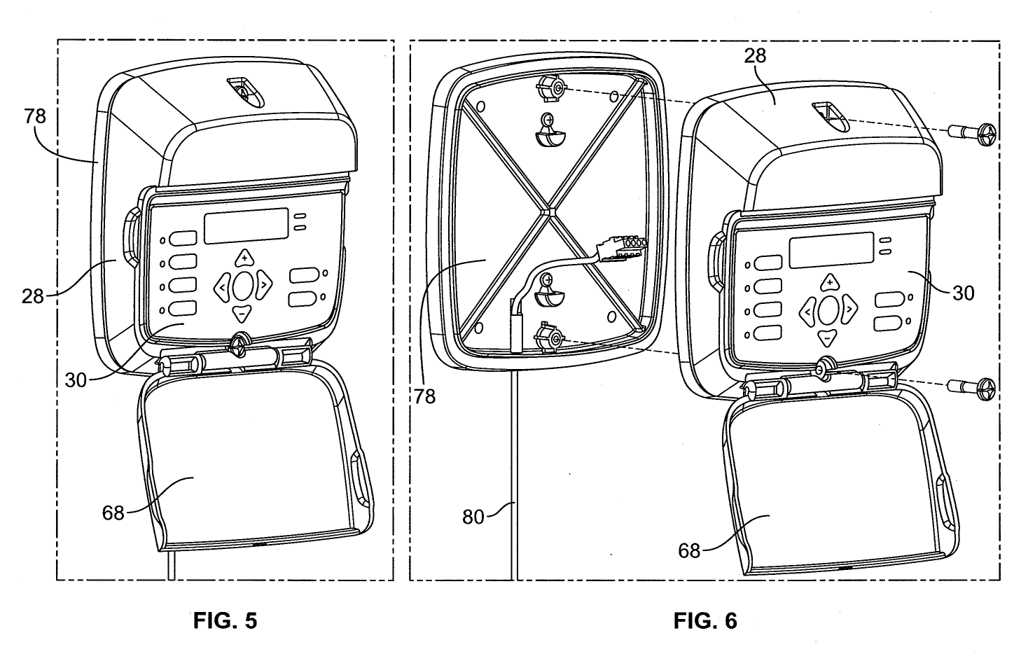

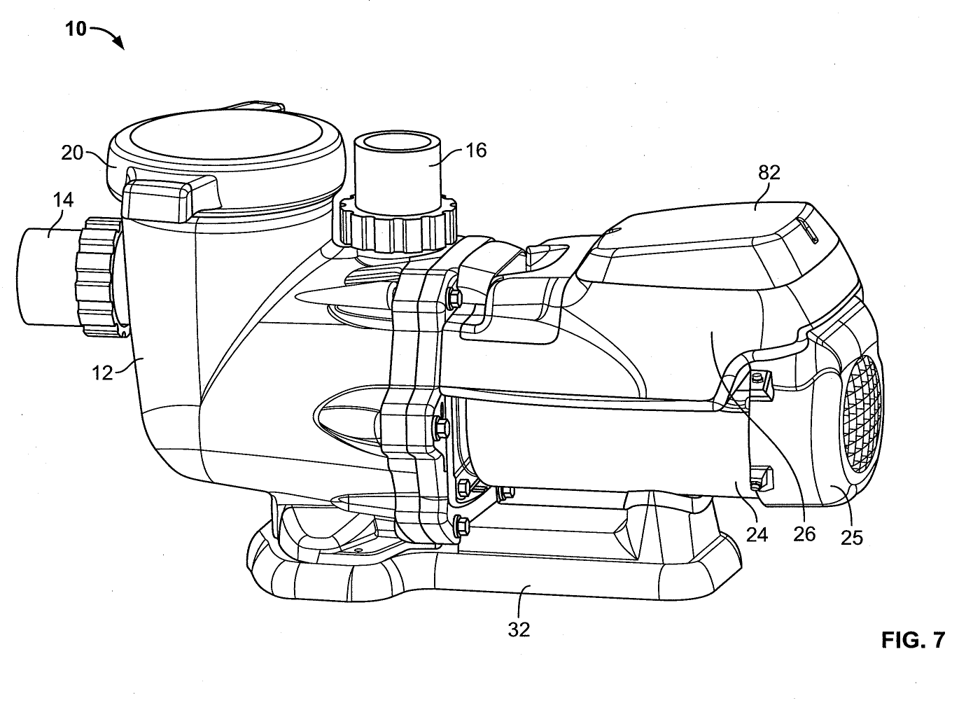

With reference to FIGS. 5 and 6, the interface module 28 could be mounted remotely from the drive assembly 26, such as in any location (for example, a vertical wall) within the vicinity of a pool. The interface module 28 is removed from the drive assembly 26, and the communication cable 38 is disconnected from the interface module 28. A mounting bracket 78 could be secured at the remote location for use in mounting the interface module 28. A communication data cable 80, such as a six-wire data cable, is connected to the drive assembly 26, routed through an opening formed in the drive assembly 26, through a channel formed in the mounting bracket 78, and is then connected to the interface module 28. In one embodiment, the remotely positioned interface module 28 is in communication with the electrical components through a wireless connection.

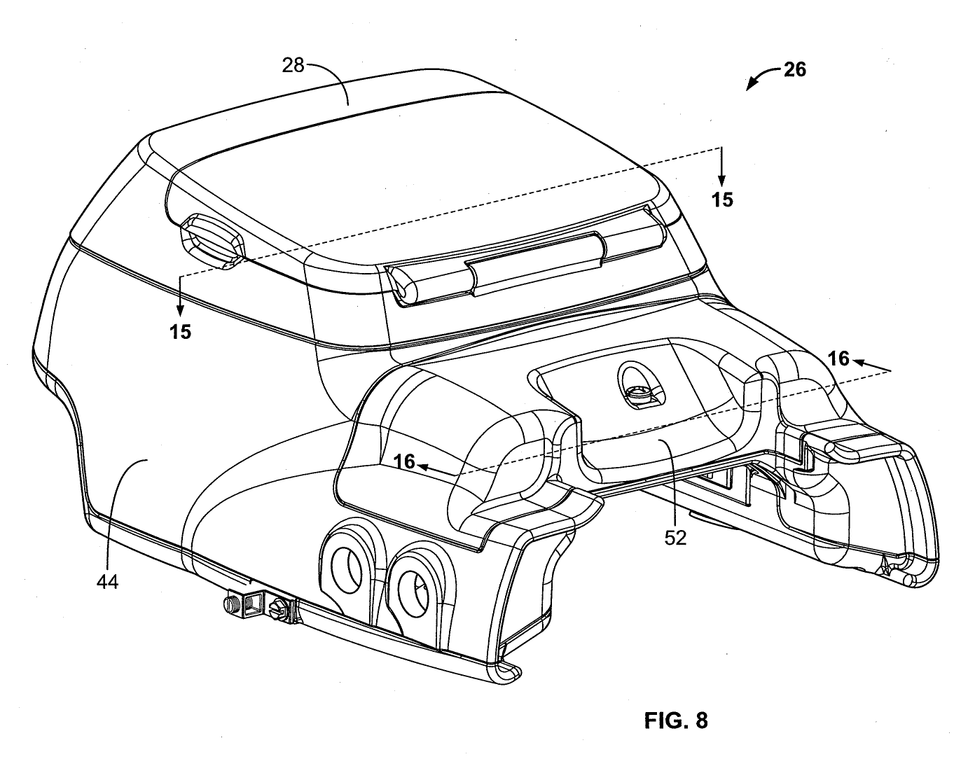

A blank cover 82 (see FIG. 7) could be positioned over the drive assembly 26 when the interface module 28 is remotely mounted. The blank cover 82 is used to protect the communication cable 38.

It will be understood that the embodiments described herein are merely exemplary and that a person skilled in the art may make many variations and modifications without departing from the spirit and scope of the disclosure. All such variations and modifications are intended to be included within the scope of the disclosure as defined by the appended claims.

What is claimed is:

1. A variable speed pumping system comprising:
a pumping assembly including at least a pump, a motor, and a drive assembly; said pumping assembly having a mount; and
a user interface selectively positionable among a plurality of positions with respect to said mount.

2. The variable speed pumping system of claim 1, wherein said drive assembly includes said mount.

3. The variable speed pumping system of claim 2, wherein said mount is an exterior surface of said drive assembly.

4. The variable speed pumping system of claim 1, wherein said user interface is located remotely from said pumping assembly, and said user interface is in communication with said pumping assembly.

5. The variable speed pumping system of claim 1, wherein said mount has a center point and a plurality of apertures, said center point positioned generally equidistant from each of said plurality of apertures.

6. The variable speed pumping system of claim 5, wherein said plurality of apertures include adjacent pairs of apertures, one of said adjacent pair of said plurality of apertures is positioned generally equidistant from another of said adjacent pair of said plurality of apertures.

7. The variable speed pumping system of claim 6, wherein said user interface has a center point and a plurality of apertures, said center point positioned generally equidistant from each of said plurality of apertures.

8. The variable speed pumping system of claim 7, wherein said plurality of apertures of said mount is aligned with said plurality of apertures of said user interface when said user interface is vertically aligned with said mount.

9. The variable speed pumping system of claim 1, wherein said plurality of positions includes a first position, a second position, a third position, and a fourth position, said user interface selectively positionable between said first position, said second position, said third position, and said fourth position.

10. A method for selectively positioning a user interface relative to a pumping assembly including at least a pump, a motor, and a drive assembly, the method comprising the steps of:
(a) mounting the user interface to the pumping assembly in a first position; and
(b) moving the user interface to a second position with respect to the pumping assembly, the second position being different from the first position.

11. The method of claim 10, further comprising the step of removing the user interface from the pumping assembly.

12. The method of claim 11, further comprising the step of moving the user interface to a third position with respect to the pumping assembly.

13. The method of claim 12, wherein the step of moving the user interface to a second position with respect to the pumping assembly comprises rotating the user interface to a second position with respect to the pumping assembly.

14. The method of claim 13, wherein the step of moving the user interface to a second position with respect to the pumping assembly comprises removing the user interface from the pumping assembly, and mounting the user interface at a remote location relative to the pumping assembly.

15. A variable speed pumping assembly comprising:
a pump;
a variable speed motor in communication with said pump;
a drive assembly sized to control said variable speed motor; and
a user interface selectively positionable among a plurality of positions with respect to one of said pump, said variable speed motor, and said drive assembly.

16. The variable speed pumping assembly of claim 15, wherein said user interface is selectively positionable among a plurality of positions on said drive assembly.

17. The variable speed pumping assembly of claim 15, wherein said user interface is located remotely from said drive assembly, and said user interface is in communication with said drive assembly.

18. The variable speed pumping assembly of claim 17, wherein said drive assembly has a center point and a plurality of apertures, said center point positioned generally equidistant from each of said plurality of apertures.

19. The variable speed pumping assembly of claim 18, wherein said plurality of apertures include adjacent pairs of apertures, one of said adjacent pair of said plurality of apertures is positioned generally equidistant from another of said adjacent pair of said plurality of apertures.

20. The variable speed pumping assembly of claim 19, wherein said user interface has a center point and a plurality of apertures, said center point positioned generally equidistant from each of said plurality of apertures.
